(19) United States
(12) Patent Application Publication
(10) Pub. No.: US 2012/0043698 A1
(43) Pub. Date: Feb. 23, 2012

(54) METHODS FOR CONSTRUCTION OF SLAB TRACK RAILROADS

(76) Inventors: Douglas Delmonico, Broomfield, CO (US); Fabien Weber, Boulder, CO (US)

(21) Appl. No.: 13/212,746

(22) Filed: Aug. 18, 2011

Related U.S. Application Data
(60) Provisional application No. 61/401,733, filed on Aug. 18, 2010.

(51) Int. Cl. B28B 7/30

(52) U.S. Cl. 264/313; 249/1

(57) ABSTRACT

A method for construction of a concrete platform for use in slab track railroads, comprising supporting a tie plate and rail on a concrete form for casting the concrete platform. The concrete form includes a horizontal form positioned below the tie plate, that supports a cast in place fastener system that is imbedded in the surface of the concrete platform and secures the tie plate to the concrete platform. The horizontal form comprises a removable or sacrificial insert that is cast into the surface of the concrete platform. Materials such as expanded polystyrene can be used to make sacrificial inserts that can be removed by dissolving with solvents such as dibasic esters. After the concrete platform is cast, the removable insert is removed and the resulting cavity is filled with a filler material, all without the need to disassemble the tie plate and rail.

### BACKGROUND OF INVENTION

This application claims the benefit of U.S. Provisional Application No. 61/401,733, filed Aug. 18, 2010, which is hereby incorporated by reference in its entirety.

Railroads are typically comprised of two load bearing steel rails which support the train's wheels. Some railroads are constructed using wooden, concrete, steel, or composite cross-ties to align and support the steel rails. The area between the cross-ties is commonly filled with rock ballast to hold the track in place. Another method exists wherein concrete cast in place pads or platforms are used that are functionally similar to cross-ties and align and support the rails. The area between the raised platforms is typically filled with concrete, as opposed to rock ballast. This system is often referred to as “slab track” and is frequently used for commuter type railroads.

One method of constructing slab track railroads comprises building, assembling, and aligning the rails in place, supporting the rails with concrete forms for casting the raised platform, and then pouring the concrete to cast the platform beneath the rails, as shown in FIGS. 1 and 2. This method is commonly referred to as “top down” construction, and allows the builder to cast the concrete platform with reference to the rails, which are geometrically the items of critical importance.

Slab track, like other railroad designs, utilizes tie plates beneath the steel rails that function as a bearing plate to spread the reaction forces of the rails over a larger area of contact on the supporting structure. The tie plates are typically secured to the concrete platform using a threaded fastener system that serves to anchor the tie plate and, consequently, the rail to the concrete platform. A portion of the fastener system, such as a threaded insert, is commonly cast into the surface of the concrete platform during construction of the slab track, as shown in FIG. 3. The threaded insert or other fastener system is typically positioned and supported on a horizontal portion of the concrete form that is used to cast the raised platform. This horizontal form must occupy the space directly above the fastener system that is cast into the concrete, otherwise the horizontal form would also become imbedded in the concrete platform. In general, the horizontal form is a horizontal plate located directly above the top surface of the concrete platform where the tie plate will be placed, although the exact location and orientation is determined by the track design. The horizontal form is usually roughly the same size and shape or slightly larger than the footprint of the tie pad.

When pouring and casting the concrete platform, pockets of air are often captured under the horizontal form. As a result, it is typical for voids to form in the surface of the cast concrete platform that was under the horizontal form, as shown in FIG. 3. These voids can cause incomplete surface contact between the tie plate and the surface of the concrete platform, resulting in uneven load concentrations. The voids also increase the possibility that liquids or solids may collect between the tie plate and the surface of the concrete platform, which can increase the rate of degradation of the concrete on exposure to repeated freeze thaw cycles.

It is common practice to fill any voids in the concrete surface where the tie plate will be placed. Various commercially available materials can be used to fill the voids, including grout and epoxy. However, this process can be time and labor intensive, and requires removal of the rail assembly along with the concrete forms in order to access the voids below the forms. The material used to fill the voids must be applied and allowed to cure, and then the tie plate installed and rail must be reassembled before the railroad is usable for train traffic.

### SUMMARY OF THE INVENTION

Methods for constructing slab track railroad are disclosed, wherein the slab track has a concrete platform supporting a tie plate and rail assembly. In one embodiment, the method comprises providing a form for casting a concrete platform, the form supporting a tie plate and rail assembly. A removable insert is positioned beneath the tie plate and concrete is poured into the form to cast the concrete platform with the removable insert cast into and imbedded in the surface of the concrete platform. The removable insert is removed from the concrete platform to create a cavity in the surface of the concrete platform beneath the tie plate. The cavity is then filled with a filler material.

In yet another embodiment, a form for casting a concrete platform supporting a railroad tie plate is disclosed, the form comprising a horizontal form having a top surface positioned to face toward the tie plate and a bottom surface positioned to be imbedded in the cast platform. The bottom surface of the horizontal form has a removable insert.

### BRIEF DESCRIPTION OF THE DRAWINGS

FIG. 1 shows a finished concrete platform, tie plate and rail,

FIG. 2 shows a prior art concrete form supporting a tie plate and rail, for casting a concrete pad with an imbedded threaded insert.

FIG. 3 shows the surface of a concrete platform cast using the concrete form of FIG. 2, which exhibits voids in the portion of the surface formed beneath the horizontal form (not shown).

FIG. 4a is a top view of a tie plate and horizontal form including a removable insert.

FIG. 4b is a partial vertical section view of the tie plate and horizontal form of FIG. 4a, taken along line A-A.

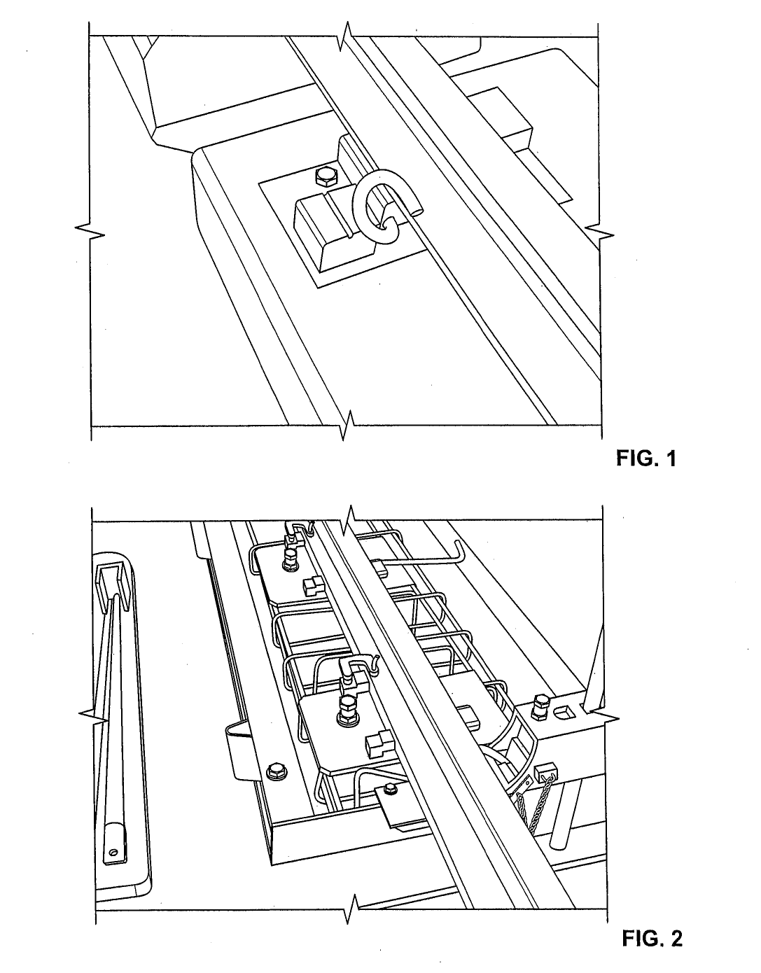

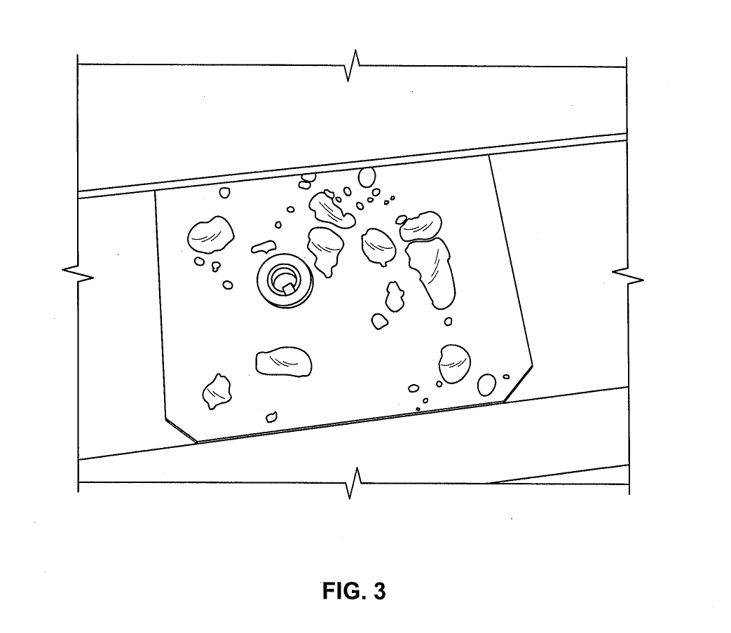

### DETAILED DESCRIPTION OF THE INVENTION

A method for constructing a slab track railroad is described, wherein the horizontal form that supports the fastener system includes or is replaced by an insert that is removably cast in the surface of the concrete platform and prevents concrete from entering into the space occupied by the insert. The removable insert is positioned in the load bearing area of the surface of the concrete platform beneath the tie plate. Once the concrete platform is cast, the insert is removed, creating a cavity in the surface of the concrete platform beneath the tie plate. The cavity is then filled with an epoxy or other material,

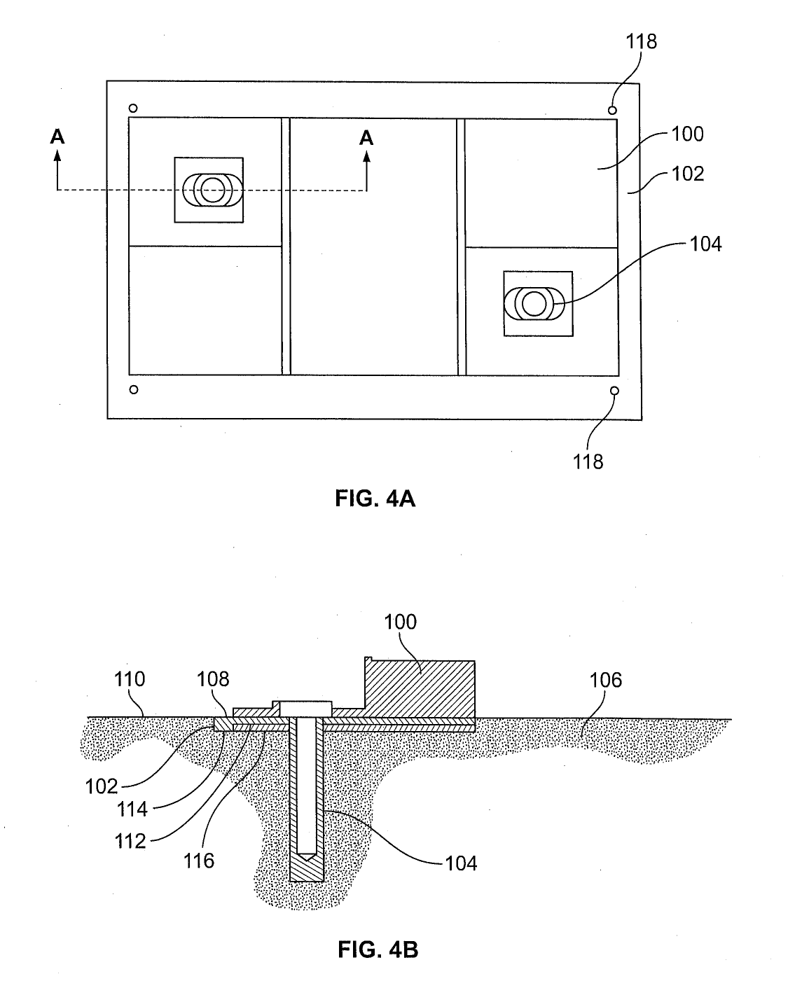

In one embodiment, the removable insert is a sacrificial insert made of a material that is dissolvable by a solvent. Once the concrete platform has cured to a sufficient state, an appropriate solvent can be injected beneath the tie plate to dissolve the sacrificial insert. An example of a sacrificial insert is shown in FIGS. 4a and 4b, which depicts a tie plate 100 and a horizontal form 102 that supports a threaded insert 104. In this embodiment, horizontal form 102 is east and imbedded into concrete platform 106 such that the top surface 108 of the horizontal form facing the tie plate 100 is even with the top surface 110 of concrete platform 106. Horizontal form 102 supports threaded insert 104, which is cast into concrete platform 106 and receives a threaded bolt (not shown) to secure tie plate 100 to the raised platform. The bottom surface of horizontal form 102 opposite top surface 108 is imbedded in the cast platform 106. In a preferred embodiment, the bottom surface has a well 112 that is defined by shoulders 114. Well 112 is filled with a dissolvable material that forms a sacrificial insert 116. One or more openings 118 may be provided in the top surface 108 of the horizontal form 102 to serve as injection ports for the application of the solvent to sacrificial insert 116, and/or as vent holes for removal of the dissolved material. After removal of the dissolved material and solvent, the resulting cavity can be filled with epoxy or other materials known in the art. This process permits significant time savings in the construction of slab track by avoiding the need to disassemble the concrete form, tie plate and rail.

The horizontal form may be made of a number of different materials that are known in the art. In a preferred embodiment, the horizontal form is made of high density polyethylene. Suitable dissolvable materials for the sacrificial insert include polymeric materials, such as commercially available 1 pound per cubic foot (pcf) density expanded polystyrene. Suitable solvents for an expanded polystyrene insert include dibasic esters, which will dissolve the sacrificial insert relatively quickly, while not affecting the cast in place horizontal form, the concrete or the final filler material. In a preferred embodiment, the sacrificial insert is dissolved in about 5 minutes or less, and more preferably in about 2 minutes or less, to allow efficient construction of the slab track. In a further preferred embodiment, a ratio of approximately 6 grams of dibasic ester to each gram of polystyrene is used. For example, 20 grams of dibasic ester may be used to dissolve at least 14 cubic inches of 1 pound per cubic foot polystyrene in about 1-2 minutes. Those of skill in the art will appreciate that the dissolving time is dependant on the ratio of dibasic ester to polystyrene, the ambient temperature, contact turbulence and other factors.

In yet another embodiment, the sacrificial insert is made slightly larger than the footprint of the tie plate to permit the solvent to be directly applied to the sacrificial insert. For example, in the case where the horizontal form is replaced by a sacrificial insert, a tie plate whose footprint has a width and length of 8 inches by 16 inches preferably uses a sacrificial insert having a larger width and length with a size of 16 inches by 9 inches and a thickness of ¼ inch, that extends beyond the edges of the tie plate and would allow access directly adjacent to the tie plate for application of the solvent. This calculates to a sacrificial insert with a volume of 36 cubic inches and a weight of 9.5 grams (assuming 1 pound per cubic foot). Based on the previously discussed ratio of solvent to polystyrene, approximately 216 grams of dibasic ester would be required to dissolve the sacrificial insert. The actual amount of solvent used may be increased to speed the reaction as well as to accommodate for solvent which may be effectively lost in any voids in the concrete beneath the sacrificial polymeric insert or into the porosity of the concrete.

After a sufficient time has passed to fully dissolve the sacrificial insert, the dissolved material and any excess solvent is removed to create a cavity in the surface of the concrete platform. In one embodiment, compressed air is used to clear the dissolved material and excess solvent. Where the sacrificial insert is a part of the horizontal form, the compressed air can be introduced through the injection ports. Vent holes or other openings may be provided in the horizontal portion of the concrete form to permit ejection of the dissolved material and excess solvent.

Once the cavity has been cleared, a permanent filler material may be immediately injected into the cavity through the same openings used to fill and clear the cavity of solvent. Suitable filler materials are used, such as liquid epoxy or grout, that are not affected by the solvent. Those of skill in the art will appreciate that the filler material must be of sufficiently low viscosity to fully fill the cavity formerly occupied by the sacrificial insert as well as any voids left in the concrete. In addition, it is desirable that the filler material is able to displace any of the solvent or dissolved material that may remain in the cavity or voids beneath the cavity—preferably, either by moving excess filler through the cavity, in which case any solvent or dissolved material is carried out through the vent holes, or by displacing any solvent or dissolved material through the principle of differential density buoyancy and depositing it in a non-load bearing area of the concrete platform. Means for collecting the displaced solvent and dissolved material may also be used, such as a vacuum system.

Although the invention has been described in detail with reference to preferred embodiments, variations and modifications exist within the scope and spirit of the invention as described and defined in the following claims. In particular, those of skill in the art will appreciate that, in an alternative embodiment, the removable insert can be incorporated into the tie plate itself with slight alterations to existing tie plate designs. For example, a sacrificial insert may be applied to the bottom surface of the tie plate. Furthermore, the invention is not limited in application to any particular type or form of tie plate and rail assembly, or configuration of slab track.

What is claimed is:

1. A method for casting a concrete platform supporting a railroad tie plate, comprising the steps of:
providing a form for casting the concrete platform, the form supporting the tie plate;
positioning a removable insert beneath the tie plate;
pouring concrete into the form to cast the platform with the removable insert imbedded in the surface of the cast platform;
removing the removable insert from the concrete platform to create a cavity in the surface of the cast platform beneath the tie plate; and
filling the cavity with a filler material.

2. The method of claim 1, wherein the removable insert is made of a material dissolvable by a solvent, and further comprising the steps of:
removing the removable insert from the concrete platform by applying the solvent to dissolve the removable insert; and
removing the dissolved material to create a cavity in the surface of the concrete platform.

3. The method of claim 2, wherein the removable insert is made of expanded polystyrene and the solvent is a dibasic ester.

4. The method of claim 3, wherein the filler material is an epoxy.

5. The method of claim 2, wherein the dissolved material is removed by displacement by the filler material.

5. The method of claim 2, wherein the dissolved material is removed using compressed air.

6. The method of claim 2, further comprising the step of collecting the dissolved material using a vacuum.

7. A form for casting a concrete platform supporting a railroad tie plate, comprising a horizontal form having a top surface positioned to face toward a tie plate and a bottom surface positioned to be imbedded in the cast platform, the bottom surface having a removable insert.

8. The form of claim 7, wherein the top surface is positioned to be even with the surface of the cast platform.

9. The form of claim 7, further comprising a well formed in the bottom surface, the removable insert filling the well.

10. The form of claim 7, wherein the removable insert is made of a material that is dissolvable by a solvent.

11. The form of claim 10, wherein the top surface includes an opening for applying the solvent to the removable insert.

12. The form of claim 10, wherein the top surface includes an opening for removal of dissolved material.

13. The form of claim 10, wherein the dissolvable material comprises expanded polystyrene.

14. The form of claim 13, wherein the solvent is a dibasic ester.

15. The form of claim 7, wherein the removable insert is sized and shaped to have a width and length that are larger than the width and length of the footprint of the tie plate.

16. The form of claim 15, wherein the removable insert has a width and length that are 1 inch longer than the width and length of the footprint of the tie plate.

17. The form of claim 15, wherein the removable insert has a thickness of ¼ inch.

18. The form of claim 7, further comprising a fastener system for anchoring the tie plate to the cast platform, the anchoring system supported on the horizontal form and positioned to be imbedded in the surface of the cast platform.

19. The form of claim 18, wherein the fastener system comprises a threaded insert.

20. A form for casting a concrete platform supporting a tie plate, comprising a removable insert positioned to be imbedded in the surface of the cast platform beneath the tie plate, the removable insert having a width and length that is larger than the width and length of the footprint of the tie plate.
